(19) United States
(12) Patent Application Publication
(10) Pub. No.: US 2005/0088525 A1
(43) Pub. Date: Apr. 28, 2005

(54) Method and apparatus for managing the operation of a digital camera

(76) Inventors: Donald J. Stavely, Windsor, CO (US); Andrew C. Goris, Loveland, CO (US); Linda A. Kennedy, Fort Collins, CO (US); Victoria L. Naffier, Fort Collins, CO (US); Robert F. Yockey, Fort Collins, CO (US); Lisa K. Roberts, Fort Collins, CO (US); George Prokop, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/693,106

(22) Filed: Oct. 24, 2003

(51) Int. Cl. H04N 5/225

(52) U.S. Cl. 348/207.1

(57) ABSTRACT

A digital camera automatically sends digital images captured in a particular operating mode to a specified electronic address. The digital camera facilitates sharing of the device among multiple users or the use of the device for multiple purposes by a single user.

### FIELD OF THE INVENTION

The present invention relates generally to digital imaging and more specifically to techniques for managing the operation of a digital camera.

### BACKGROUND OF THE INVENTION

Current digital camera technology makes downloading, saving, printing, and sending digital images relatively simple and easy for a single user. Such tasks are facilitated by connecting the digital camera to a personal computer (PC) or a commercial photographic kiosk. Some digital cameras have a built-in wireless modem that enables wireless communication with an external device. Other digital cameras are designed to connect with a cellular telephone, which acts as an external wireless modem.

Difficulties arise when multiple users (e.g., a family or work group) wish to share a digital camera. Also, a stranger may ask a digital camera owner for permission to use the digital camera temporarily. For example, the parent of one child may ask the parent of another child for permission to take some pictures of a school play using the latter's digital camera. In such situations, managing which images go where is left up to the camera owner. This involves identifying which images belong to other users and manually e-mailing them to their respective owners.

It is thus apparent that there is a need in the art for an improved method and apparatus for managing the operation of a digital camera.

### SUMMARY OF THE INVENTION

A method for managing the operation of a digital camera is provided. An apparatus for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is a functional block diagram of a digital camera in accordance with an illustrative embodiment of the invention.

FIG. 1B is a conceptual diagram of a memory of the digital camera shown in FIG. 1A in accordance with an illustrative embodiment of the invention.

FIG. 1C is an illustration of input controls of the digital camera shown in FIG. 1A in accordance with an illustrative embodiment of the invention.

FIG. 2A is a block diagram of a network connection between the digital camera shown in FIG. 1A and a destination in accordance with an illustrative embodiment of the invention.

FIG. 2B is a block diagram of a network connection between the digital camera shown in FIG. 1A and a destination in accordance with another illustrative embodiment of the invention.

FIG. 3 is a flowchart of the operation of the digital camera shown in FIG. 1A in accordance with an illustrative embodiment of the invention.

### DETAILED DESCRIPTION OF THE INVENTION

Sharing of a digital camera by multiple users is facilitated by providing a selectable operating mode wherein digital images captured while the digital camera is in that operating mode are automatically sent to a particular electronic address associated with the person using the digital camera in that operating mode. For example, a first user may operate a digital camera in a first mode. When a second user wishes to use the digital camera, the first user (or the second user, depending on the situation) may switch the digital camera to a second operating mode. The second user may enter an electronic address, or the second user may select a screen name from a menu in the digital camera, the screen name having an associated electronic address. Upon connection of the digital camera to an external networked device or at a predetermined time thereafter, the digital images captured while the digital camera was in the second mode may be sent automatically to the electronic address input or selected by the second user. In this way, the second user receives his images automatically without the involvement of the first user (except for connecting the digital camera with a an external device or wireless network). The first user may have a profile in conjunction with the first mode. Optionally, the first user's profile may be protected from viewing and/or modification while the digital camera is in the second mode. A profile may include, for example, digital images, camera settings, and one or more electronic addresses that are associated with the first user. A profile may also include instructions for operations that are to be performed at an address destination. Example instructions include printing the images or adding them to a Web site.

The foregoing approach is not limited to situations in which multiple users share a digital camera. For example, a single user may wish to separate pictures taken for personal use from those taken for work. The single user may, for example, use the first operating mode for work-related images and the second operating mode for personal images. Personal images may be sent automatically to a personal e-mail address, and the work-related images may be left behind on the digital camera or routed to a different destination (e.g., a work e-mail address or a directory on an office personal computer or server). In general, the invention is applicable to any situation in which it is desirable to associate a set of images taken by a digital camera with an electronic address to which those images are to be sent automatically. Throughout this description, “digital image” and “image” will be used interchangeably.

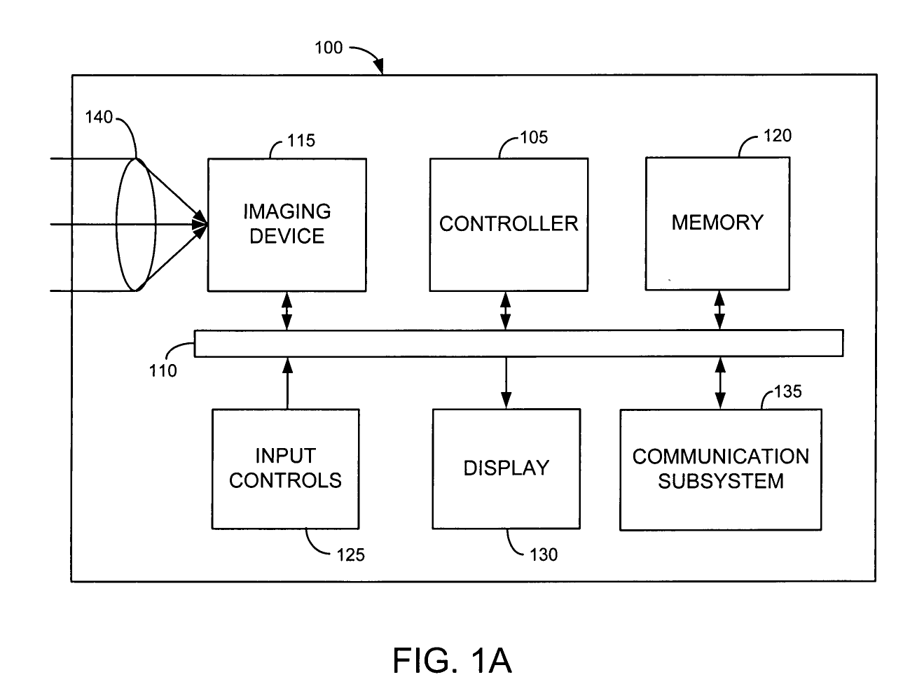

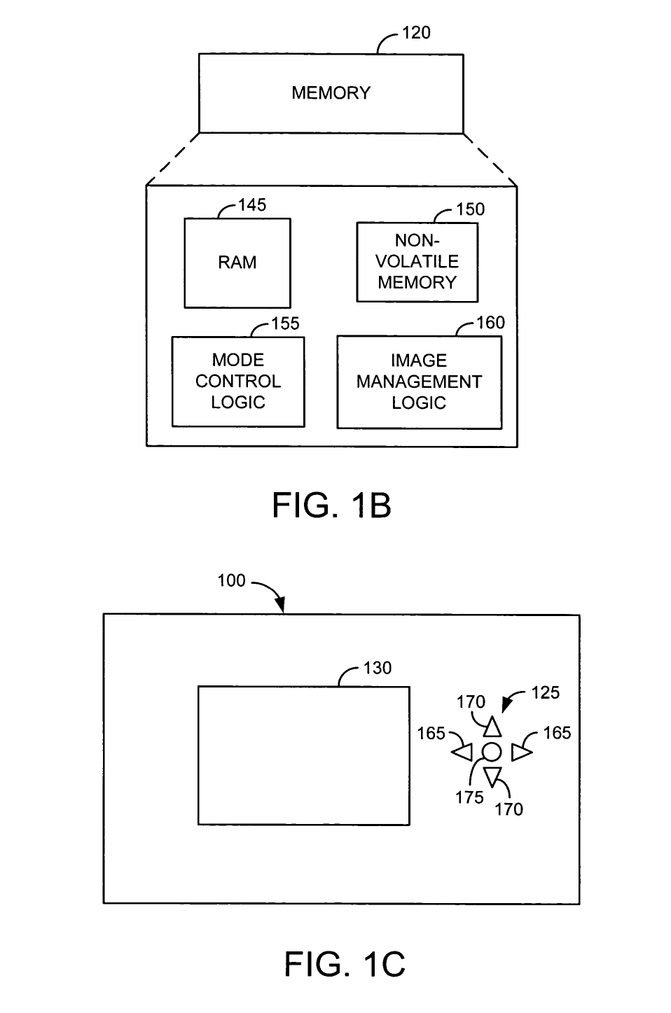

FIG. 1A is a functional block diagram of a digital camera 100 in accordance with an illustrative embodiment of the invention. In FIG. 1A, controller 105 communicates via data bus 110 with imaging device 115, memory 120, input controls 125, display 130, and communication subsystem 135. Imaging device 115 converts optical images received from optical system 140 to digital images, which may be stored in memory 120. Imaging device 115 may comprise a charge-coupled device is (CCD), an analog-to-digital converter (A/D), a gain control, and a digital signal processor (DSP) (not shown in FIG. 1A). Controller 105 may comprise a microprocessor or other central processing unit (CPU), and input controls 125 may include one or more buttons or switches for controlling the operation of digital camera 100. Display 130 is typically of the color liquid-crystal-display (LCD) type. Communication subsystem 135 may comprise hardware and program instructions for communicating with external devices such printers, personal computers (PCs), laptop computers, or radiotelephones (e.g., a cellular telephone). In some embodiments, communication subsystem 135 may include a wireless modem for direct communication with a wireless network.

FIG. 1B is a conceptual diagram of memory 120 of digital camera 100 in accordance with an illustrative embodiment of the invention. Memory 120 may comprise random access memory (RAM) 145, non-volatile memory 150, mode control logic 155, and image management logic 160. Non-volatile memory 150, in some embodiments, may be of the removable variety (e.g., a multi-media flash memory card). Mode control logic 155 controls switching the operation of digital camera 100 among two or more operating modes. Each operating mode may be associated with a distinct electronic address (destination) that is in turn associated with a particular user sharing digital camera 100. In other embodiments, however, a single user may use multiple operating modes, each of which has its own associated electronic address, to separate images taken for different purposes, as explained above. Image management logic 160 may associate images captured in digital camera 100 with the electronic address corresponding to the operating mode in which they are captured. Associating images with an electronic address in this fashion enables digital camera 100, via communication subsystem 135, to send the images to the associated electronic address automatically.

Image management logic 160 may associate images captured in a particular operating mode with the appropriate electronic address in a variety of ways. For example, image management logic 160 may embed the electronic address in the image files themselves (e.g., as part of a header). Alternatively, image management logic 160 may manage a separate data structure in memory 120 that records in which operating mode an image was captured and maps it to the corresponding electronic address. In some embodiments, this functionality of image management logic 160 may be integrated into the file system of digital camera 100.

The functional boundaries between mode control logic 155 and image management logic 160 indicated in FIG. 1B are arbitrary. That is, their functionality may be implemented as separate logical units or through different aspects of a single logical unit. In general, mode control logic 155 and image management logic 160 may be implemented using any combination of hardware, firmware, and software. In one embodiment, mode control logic 155 and image management logic 160 are stored-program instructions residing in non-volatile memory 150 that are executed by controller 105.

FIG. 1C is an illustration of input controls 125 of digital camera 100 in accordance with an illustrative embodiment of the invention. FIG. 1C is a view of the back of digital camera 100. Input controls 125 may include, in addition to a shutter release button (not shown in FIG. 1C), horizontal arrow buttons 165, vertical arrow buttons 170, and “ok” or menu button 175. Input controls 125 shown in FIG. 1C are merely illustrative. In other embodiments, input controls 125 may take a variety of different forms. In the context of the present invention, input controls 125 are used primarily for text entry (i.e., for the entry of electronic addresses). Most digital cameras do not include an alphanumeric keypad, but there are alternative methods for inputting text (e.g., an e-mail address) to such a device, as those skilled in the art will recognize. For example, entry of text strings may be accomplished by scrolling among a menu of alphanumeric characters on display 130 using horizontal arrow buttons 165 and vertical arrow buttons 170 and selecting desired characters for inclusion in the text string using ok/menu button 175. In another embodiment, electronic addresses may be input to digital camera 100 by downloading them from an external device such as a PC. For example, an e-mail or personal information management (PIM) program residing on a PC may be configured to download selected e-mail addresses or uniform resource locators (URLs) to digital camera 100.

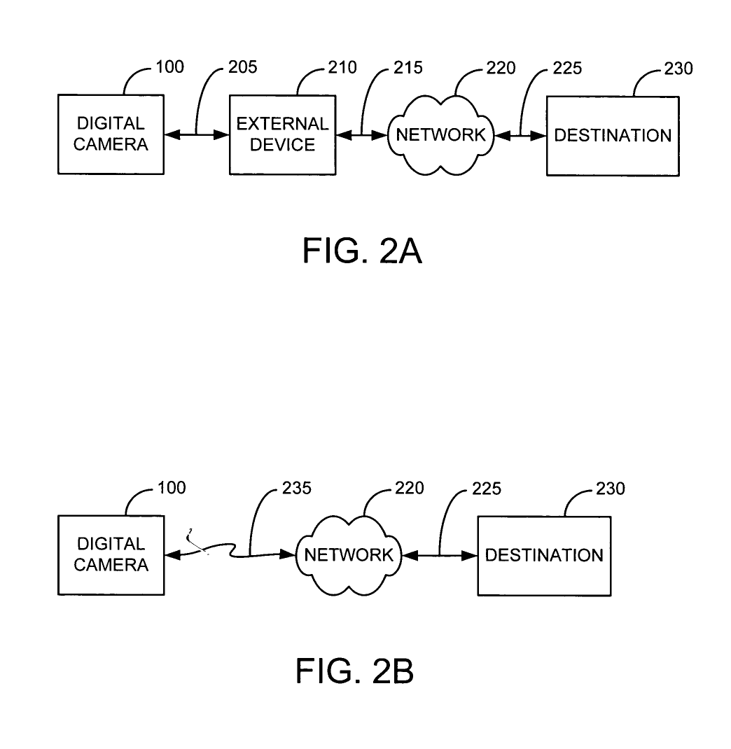

Once image management logic 160 has associated with the corresponding electronic address a set of images captured in a particular operating mode, the images may be sent automatically to the electronic address. FIGS. 2A and 2B illustrate some of the many ways in which transmission of the images to the electronic address may be accomplished.

In FIG. 2A, digital camera 100 communicates over communication link 205 with an external device 210. External device 210 communicates over communication link 215 with a network 220. Network 220 is connected via communication link 225 to a destination 230. External device 210 is any device capable of sending data to or receiving data from digital camera 100. Examples include a PC, commercial photographic kiosk, cellular phone, printer, server, laptop computer, a docking station, or any similar device. If external device 210 is a cellular phone, the cellular phone may serve as a wireless modem, and communication link 215 becomes wireless. Network 220 may be, e.g., the Internet, a wide-area network (WAN), or a local-area network (LAN). Destination 230 may be a desktop PC, a laptop PC, a network server, an e-mail server, an ftp server, a Web site, or other data sink to which images from digital camera 100 may be sent.

In FIG. 2B, communications subsystem 135 of digital camera 100 includes a built-in (internal) wireless modem. In this embodiment, images may be sent from digital camera 100 to network 220 over wireless link 235. This embodiment also obviates the need for an external device 210 because digital camera 100 may transmit images directly to a cellular, PCS, or other wireless network (e.g., a WLAN).

The electronic address corresponding to destination 230 may be any of a variety of different types. For example, the electronic address may be an electronic mail (e-mail) address. In other embodiments, the electronic address may be a uniform resource locator (URL). A URL is a standard method for specifying the location of a resource that is accessible electronically via a computer network and includes both a method of access (a protocol) and a network address. Typical protocols include, for example, hypertext transfer protocol (“http”), file transport protocol (“ftp”), post office protocol (“mailto”), “gopher,” and “news.” A URL may also point to a local file or directory stored on a PC or server. URLs specifying some protocols such as ftp may also include a password and a user name. A URL such as http://www.yahoo.com/, for example, identifies the address on the World Wide Web (“www”) of the home page of the popular search engine Yahoo.

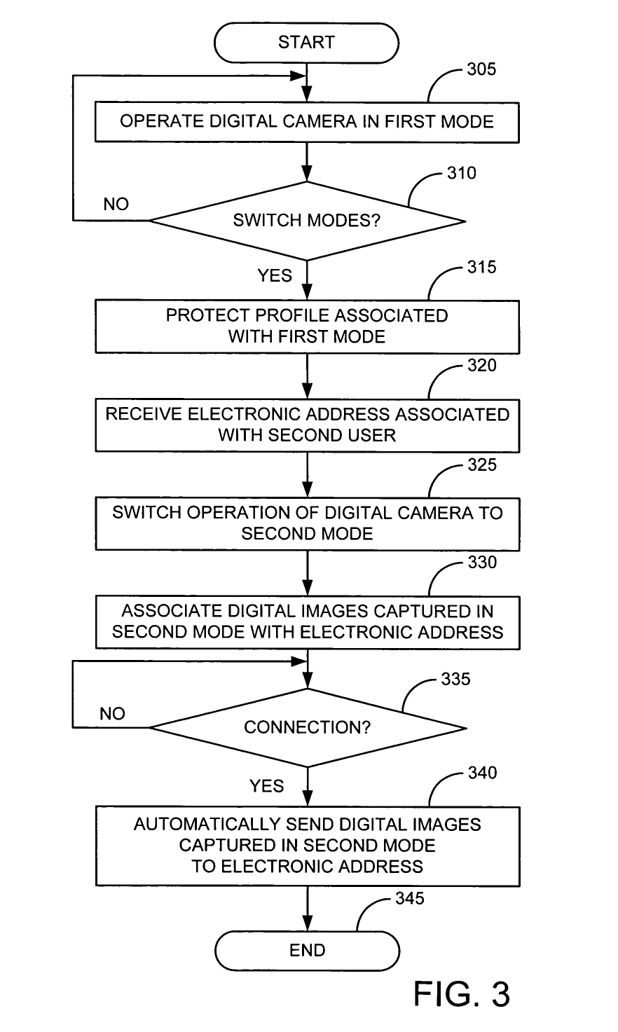

FIG. 3 is a flowchart of the operation of digital camera 100 in accordance with an illustrative embodiment of the invention. At 305, digital camera 100 may be operated in a first mode. In one embodiment, the first mode is a “primary user” mode associated with a first (primary) user. If a request to switch modes is received at 310, control proceeds to 315, where, optionally, a profile associated with the first mode may be protected from viewing and/or modification. Protecting the profile associated with the first mode allows the first user to loan digital camera 100 to a second user without worrying about privacy, the loss of images, or the changing of settings. In general, the request to switch modes at 310 may come from the first user or a second user. In some embodiments, the first and second users may be one and the same person.

At 320, digital camera 100 receives an electronic address associated with a second user. For example, the second user may enter the electronic address using input controls 125, or the second user may select his or her screen name from a list or menu stored in digital camera 100. Each stored screen name may have an associated electronic address that, when the corresponding screen name is selected, becomes effective while digital camera 100 is in a second operating mode. In some embodiments, the electronic addresses and/or screen names may be downloaded to digital camera 100 from an external device 210.

At 325, mode control logic 155 switches the operation of digital camera 100 from the first mode to a second mode in which image management logic 160 automatically associates digital images captured by digital camera 100 with the electronic address received at 320. In one embodiment, the second mode may be a “borrow” mode enabling digital camera 100 to be used by a user other than the primary user. Viewed differently, the second mode may be one of a plurality of user “accounts” on digital camera 100. When a secondary user wishes to use digital camera 100, he or she “logs onto” digital camera 100 by providing an electronic address (step 320) to which images captured while digital camera 100 is in that user's “account” are to be sent. In another embodiment, the second mode may simply be an alternate operating mode used by a single user to route images taken for a particular purpose to a specific electronic address. In such an embodiment, the first user and the second user in the foregoing description are, of course, one and the same person.

If a connection to the electronic address received at 320 via an external device 210 or a wireless communication link 235 is available at 335, the images captured by digital camera 100 in the second mode are automatically sent, at 340, to the electronic address received at 320. In some embodiments, sending of the images may commence immediately upon connection. In other embodiments, transfer of the images may occur at a scheduled time or after a predetermined delay. The process terminates at 345.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for managing the operation of a digital camera, comprising:
operating the digital camera in a first mode;
entering a second mode in the digital camera in response to a request from a user;
receiving in the digital camera an electronic address associated with the second mode;
associating with the electronic address at least one digital image captured while the digital camera is in the second mode; and
sending automatically the at least one digital image to the electronic address.

2. The method of claim 1, further comprising:
protecting a profile associated with the first mode while the digital camera is in the second mode.

3. The method of claim 2, wherein protecting a profile associated with the first mode comprises preventing the profile from being viewed.

4. The method of claim 2, wherein protecting a profile associated with the first mode comprises preventing the profile from being modified.

5. The method of claim 2, wherein the profile comprises settings of the digital camera, at least one digital image, and an electronic address that are associated with the first mode.

6. The method of claim 1, wherein the electronic address associated with the second mode is received via input controls of the digital camera.

7. The method of claim 1, wherein the electronic address associated with the second mode is retrieved from a list of screen names and their corresponding electronic addresses stored in the digital camera.

8. The method of claim 1, wherein the electronic address associated with the second mode is received from an external device.

9. The method of claim 1, wherein the first mode is associated with a first user and the second mode is associated with a second user.

10. The method of claim 1, wherein the at least one digital image is sent to the electronic address via an external device with which the digital camera is in communication.

11. The method of claim 10, wherein the external device is one of a personal computer, a commercial photographic kiosk, and a radiotelephone.

12. The method of claim 1, wherein the at least one digital image is sent to the electronic address via a wireless communication link.

13. The method of claim 1, wherein the electronic address associated with the second mode is an e-mail address.

14. The method of claim 1, wherein the electronic address associated with the second mode is a uniform resource locator.

15. A digital camera, comprising:
mode control logic configured to switch the operation of the digital camera between a first mode and a second mode, the second mode having an associated electronic address;
an imaging module to convert optical images to digital images;
image management logic configured to associate with the electronic address at least one digital image produced by the imaging module while the digital camera is in the second mode; and
a communication subsystem configured to send automatically the at least one digital image to the electronic address.

16. The digital camera of claim 15, further comprising:
input controls for entry of the electronic address.

17. The digital camera of claim 15, wherein the mode control logic is further configured to protect a profile associated with the first mode while the digital camera is in the second mode.

18. The digital camera of claim 17, wherein the mode control logic is configured to prevent the profile from being viewed.

19. The digital camera of claim 17, wherein the mode control logic is configured to prevent the profile from being modified.

20. The digital camera of claim 17, wherein the profile comprises settings of the digital camera, at least one digital image, and an electronic address that are associated with the first mode.

21. The digital camera of claim 15, further comprising:
a memory to store a list of screen names and their corresponding electronic addresses, wherein the mode control logic is further configured to retrieve from the list the electronic address associated with the second mode.

22. The digital camera of claim 15, wherein the communication subsystem is further configured to receive the electronic address from an external device.

23. The digital camera of claim 15, wherein the communication subsystem is configured to send the at least one digital image to the electronic address via an external device with which the communication subsystem is in communication.

24. The digital camera of claim 23, wherein the external device is one of a personal computer, a commercial photographic kiosk, and a radiotelephone.

25. The digital camera of claim 15, wherein the communication subsystem includes a wireless modem.

26. The digital camera of claim 15, wherein the first mode is associated with a first user and the second mode is associated with a second user.

27. The digital camera of claim 15, wherein the electronic address associated with the second mode is an e-mail address.

28. The digital camera of claim 15, wherein the electronic address associated with the second mode is a uniform resource locator.

29. A digital camera, comprising:
means for switching the operation of the digital camera between a first mode and a second mode, the second mode having an associated electronic address;
means for converting optical images to digital images;
means for associating with the electronic address at least one digital image produced by the means for converting optical images to digital images while the digital camera is in the second mode; and
means for automatically sending the at least one digital image to the electronic address.

30. The digital camera of claim 29, further comprising:
means for inputting the electronic address associated with the second mode.

31. The digital camera of claim 29, further comprising:
means for protecting a profile associated with the first mode while the digital camera is in the second mode.

32. The digital camera of claim 29, wherein the first mode is associated with a first user and the second mode is associated with a second user.

33. The digital camera of claim 29, wherein the electronic address associated with the second mode is an e-mail address.

34. The digital camera of claim 29, wherein the electronic address associated with the second mode is a uniform resource locator.
